(19) United States
(12) Patent Application Publication
(10) Pub. No.: US 2011/0173224 A1
(43) Pub. Date: Jul. 14, 2011

(54) SYSTEM AND METHOD FOR COMPLEX CALCULATIONS AND AGGREGATIONS IN RELATIONAL AND OLAP DATABASES

(76) Inventors: Custodio Fernando TOLEDO, Sao Paulo (BR); Reinaldo ACOSTA, III, Miami, FL (US)

(21) Appl. No.: 12/986,262

(22) Filed: Jan. 7, 2011

Related U.S. Application Data
(60) Provisional application No. 61/293,333, filed on Jan. 8, 2010.

(51) Int. Cl. G06F 17/30

(52) U.S. Cl. 707/769; 707/E17.014

(57) ABSTRACT

A system, method, and computer program product for performing complex calculations and aggregations in relational or OLAP databases. The inventive method analyzes an Extensible Markup Language (XML) query statement, reads relevant data from the primary data source, applies calculations specified in the XML query statement to the relevant data, and generates a resulting data set per the XML query statement. Optionally, an audit log data detailing the steps executed in the calculation can be generated. An XML based schema is used for describing elements required in the calculations and aggregations. The inventive method generates a data set that follows substantially the same format of data output generated by the database in which the system is optionally embedded and primary data source resides. The inventive method reads, calculates, and generates the resulting data set using one single pass over the data.

### CROSS-REFERENCE TO RELATED APPLICATION

This application is claims priority to U.S. Provisional Patent Application Ser. No. 61/293,333 filed Jan. 8, 2010, entitled SYSTEM AND METHOD FOR COMPLEX CALCULATIONS AND AGGREGATIONS IN RELATIONAL AND OLAP DATABASES, the entirety of which is incorporated herein by reference.

### STATEMENT REGARDING FEDERALLY SPONSORED RESEARCH OR DEVELOPMENT

n/a

### FIELD OF THE INVENTION

The present invention relates to database management systems and, more specifically, to a system and method for performing complex calculations and aggregations in relational or OLAP databases.

### BACKGROUND OF THE INVENTION

Relational Database Management (“RDBM”) systems and Online Analytical Processing (“OLAP”) database systems have been in existence for many years. They are powerful in performing basic numeric aggregations and calculations like SUM, AVERAGE, MAXIMUM, MINIMUM, COUNT, etc. over sets of data. More complex calculations or aggregations require leveraging custom-built implementations, usually done outside the database. The need for more complex calculations are evidenced by industry specific (e.g.: finance, engineering, etc.) calculation requirements.

When such complex calculations or aggregations are required, the straightforwardness of declarative languages like Structured Query Language (“SQL”) and Multidimensional Database Expression (“MDX”) are then only used to feed data into a custom system to perform required calculations and not to provide the final calculated results. To further complicate matters, the usage of the results of the data generated by the custom system used to perform the calculations are not provided in an easy-to-consume format when compared to the data results of a SQL query or MDX query.

What is therefore needed is a system and associated method for describing the data query and associated calculations in a declarative and universal way such that other systems can easily consume the final results and where, in some circumstances, audit log data is provided showing step-by-step how the calculations are performed.

### SUMMARY OF THE INVENTION

The present invention advantageously provides a method and system that makes use of an Extensible Markup Language (“XML”) schema to describe the complex calculation query to be run on the database. This XML schema includes all of the definitions of the calculations to be performed in the database query. A calculation engine, which may be embedded in the database, consumes the XML based query, performs all calculations and returns a resulting data set compatible with the database format.

In one aspect of the invention, a method for performing calculations on data in a primary data source is provided. The method includes analyzing an XML query statement, reading relevant data from the primary data source, applying calculations specified in the XML query statement to the relevant data, and generating a resulting data set per the XML query statement.

In another aspect, a system for performing calculations on data in a primary data source is provided. The system includes a database containing relevant data, and a calculation engine adapted to analyze an XML query statement, read the relevant data from the database, apply calculations specified in the XML query statement to the relevant data, and generate a resulting data set per the XML query statement.

In yet another aspect of the invention, a computer program product tangibly embodied in a computer storage medium is provided. The computer program executes instructions on a processor and is operable to cause a machine to analyze an XML query statement, read relevant data from the primary data source, apply calculations specified in the XML query statement to the relevant data, and generate a resulting data set per the XML query statement.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an embodiment of a system constructed in accordance with the principles of the present invention;

FIG. 2 is a diagram of a flowchart illustrating the steps performed by an embodiment of the present invention;

FIG. 3 is an illustration of an exemplary data set created by an embodiment of the present invention using an XML query as its input; and

FIG. 4 is an illustration showing the relationship between entries in the data cache and the output from the calculation engine constructed in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for performing complex calculations and aggregations in relational or OLAP databases.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a system, computer program product, and method (collectively referred to herein as “the system” or “the current system” or “the inventive system”) for performing complex calculations and aggregations in relational or OLAP databases. The inventive system describes a query and calculations in a declarative fashion and generates results, computed by a calculation engine and its processor, on a commonly used data format to be consumed. The present system can optionally generate audit log data detailing the steps executed in the calculation. An XML based schema is used for describing elements required in complex calculations and aggregations. The inventive system generates a data set that follows the same or substantially the same format of data output generated by the database in which the system is optionally embedded and in which the primary data source resides. The inventive system reads, calculates, and generates the resulting data set using one single pass over the data.

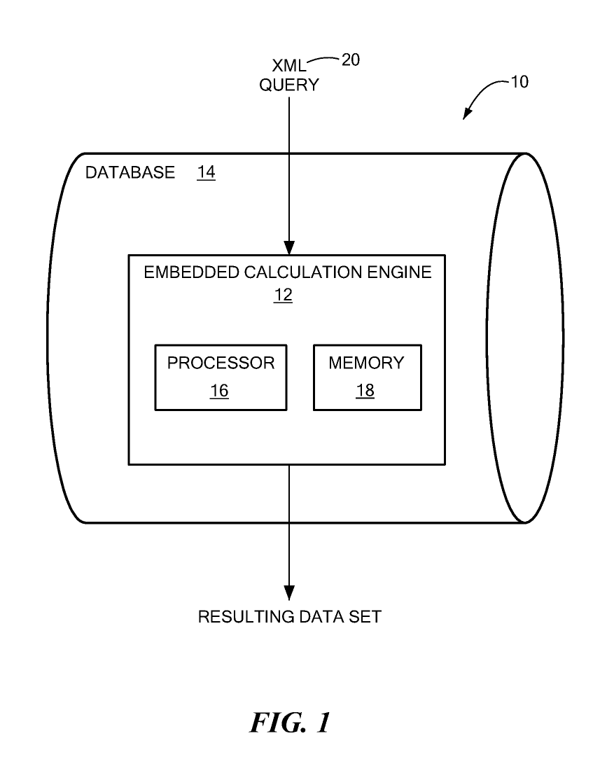

Referring now to the drawing figures in which like reference designators refer to like elements, there is shown in FIG. 1 an exemplary configuration of the system 10 of the present invention that includes a calculation engine 12 embedded within a database 14. In the embodiment shown in FIG. 1, calculation engine 12 is embedded within database 14. However, calculation engine 12 can be located remotely and be used to operate upon the data stored in database 14. Calculation engine 12 includes a processor 16, memory 18, and the associated hardware and software necessary to perform functions upon data stored within database 14.

The present system utilizes Extensible Markup Language (“XML”) to define the query 20. This XML-based query 20 embeds the description of the components used for generating the final results. The components may include, but are not limited to: 1) data layout of final result set, including “dimensions” (data attributes) to be presented alongside the calculations; 2) primary data source used for calculations and final result set; 3) measures that define behavior for each calculation; and 4) data mapping between a primary data source and data elements used in the calculations.

The following is an exemplary XML schema (“XSD”). The XSD defines the four components described above, which defines the valid XML query 20 that can be used by an embodiment of the present invention. The present invention is not limited to an XML schema defining only four components but may embed any number and any type of components used to generate a resulting data set.

<xsd:schema xmlns:xsd=“http://www.w3.org/2001/XMLSchema” elementFormDefault=“qualified”>

<xsd:element name=“Query”>

<xsd:complexType>

<xsd:complexContent>

<xsd:restriction base=“xsd:anyType”>

<xsd:sequence>

<xsd:element name=“Dimensions”>

<xsd:complexType>

<xsd:complexContent>

<xsd:restriction base=“xsd:anyType”>

<xsd:sequence minOccurs=“0” maxOccurs=“unbounded”>

<xsd:element name=“Dimension”>

<xsd:complexType>

<xsd:complexContent>

<xsd:restriction base=“xsd:anyType”>

<xsd:sequence />
<xsd:attribute name=“Name” type=“xsd:string” use=“required” />
<xsd:attribute name=“IsTimeDimension” type=“xsd:boolean” />
<xsd:attribute name=“SourceBeginTime” type=“xsd:string” />
<xsd:attribute name=“SourceEndTime” type=“xsd:string” />

</xsd:restriction>

</xsd:complexContent>

</xsd:complexType>

</xsd:element>

</xsd:sequence>

</xsd:restriction>

</xsd:complexContent>

</xsd:complexType>

</xsd:element>
</xsd:element name=“Measures”>

<xsd:complexType>

<xsd:complexContent>

<xsd:restriction base=“xsd:anyType”>

<xsd:sequence minOccurs=“0” maxOccurs=“unbounded”>

<xsd:element name=“Measure” type=“MeasureType” />

</xsd:sequence>

</xsd:restriction>

</xsd:complexContent>

</xsd:complexType>

</xsd:element>
<xsd:element name=“ PrimaryDataSourceQuery ” type=“xsd:string” />
<xsd:element name=“NoRowCount” type=“xsd:boolean” minOccurs=“0” />

</xsd:sequence>

</xsd:restriction>

</xsd:complexContent>

</xsd:complexType>

</xsd:element>
<xsd:complexType name=“ColumnType”>

<xsd:complexContent>

<xsd:restriction base=“xsd:anyType”>

<xsd:sequence />
<xsd:attribute name=“Name” type=“xsd:string” />
<xsd:attribute name=“SourceField” type“xsd:string” use=“required” />

</xsd:restriction>

</xsd:complexContent>

</xsd:complexType>
<xsd:complexType name=“Calculation_1”>

<xsd:complexContent>

<xsd:extension base=“MeasureType”>

<xsd:sequence />
<xsd:attribute name=“Paramenter1” type=“xsd:Paramenter1Type” />
<xsd:attribute name=“Paramenter2” type=“xsd:Paramenter2Type” />

</xsd:extension>

</xsd:complexContent>

</xsd:complexType>
<xsd:complexType name=“Calculation_2”>

<xsd:complexContent>

<xsd:extension base=“MeasureType”>

<xsd:sequence />
<xsd:attribute name=“Paramenter1” type=“xsd:Paramenter1Type” />
<xsd:attribute name=“Paramenter2” type=“xsd:Paramenter2Type” />

</xsd:extension>

</xsd:complexContent>

</xsd:complexType>
<xsd:complexType name=“Calculation_n”>

<xsd:complexContent>

<xsd:extension base=“MeasureType”>

<xsd:sequence />
<xsd:attribute name=“Paramenter1” type=“xsd:Paramenter1Type” />
<xsd:attribute name=“Paramenter2” type=“xsd:Paramenter2Type” />

</xsd:extension>

</xsd:complexContent>

</xsd:complexType>
<xsd:complexType name=“MeasureType” abstract=“true”>

<xsd:complexContent>

<xsd:restriction base=“xsd:anyType”>

<xsd:sequence>

<xsd:element name=“Columns”>

<xsd:complexType>

<xsd:complexContent>

<xsd:restriction base=“xsd:anyType”>

<xsd:sequence minOccurs=“0” maxOccurs=“unbounded”>

<xsd:element name=“Column” type=“ColumnType” />

</xsd:sequence>

</xsd:restriction>

</xsd:complexContent>

</xsd:complexType>

</xsd:element>

</xsd:sequence>
<xsd:attribute name=“Name” type=“xsd:string” use=“required” />
<xsd:attribute name=“StartDate” type=“xsd:string” />
<xsd:attribute name=“EndDate” type=“xsd:string” />
<xsd:attribute name=“NeedSubtotal” type=“xsd:boolean” />

</xsd:restriction>

</xsd:complexContent>

</xsd:complexType>

</xsd:schema>

The following is an exemplary XML-based query 20 that can be used as input by an embodiment of the present invention. The XML-based query 20 conforms to the XML schema (XSD) shown above. This exemplary embodiment uses a SQL data source, but the format can also be an MDX data source.

<Query xmlns:xsi=“http://www.w3.org/2001/XMLSchema-instance”>

<Dimensions>

<Dimension Name = “Dimension1”/>
<Dimension Name = “Dimension2”/>

</Dimensions>
<Measures>

<Measure xsi:type=“Calculation_1” Name = “Measure 1” Parameter_1 = “Parameter_1_Value”

Parameter_2 = “Parameter_2_Value” NeedSubtotal=“True” >

<Columns>

<Column Name = “DataColumnInput1” SourceField = “Number1” />
<Column Name = “DataColumnInput2” SourceField = “Date1” />

</Columns>

</Measure>
<Measure xsi:type=“Calculation_2” Name = “Return” Parameter_2 = “Parameter_1_Value”

Parameter_2 = “Parameter_2_Value”>

<Columns>

<Column Name = “DataColumnInput3” SourceField = “Number2” />
<Column Name = “DataColumnInput4” SourceField = “Date1” />

</Columns>

</Measure>

</Measures>
<PrimaryDataSourceQuery>

Select Dimension1, Dimension2, Number1, Date1, Number2
From SourceTables

</ PrimaryDataSourceQuery >

</Query>

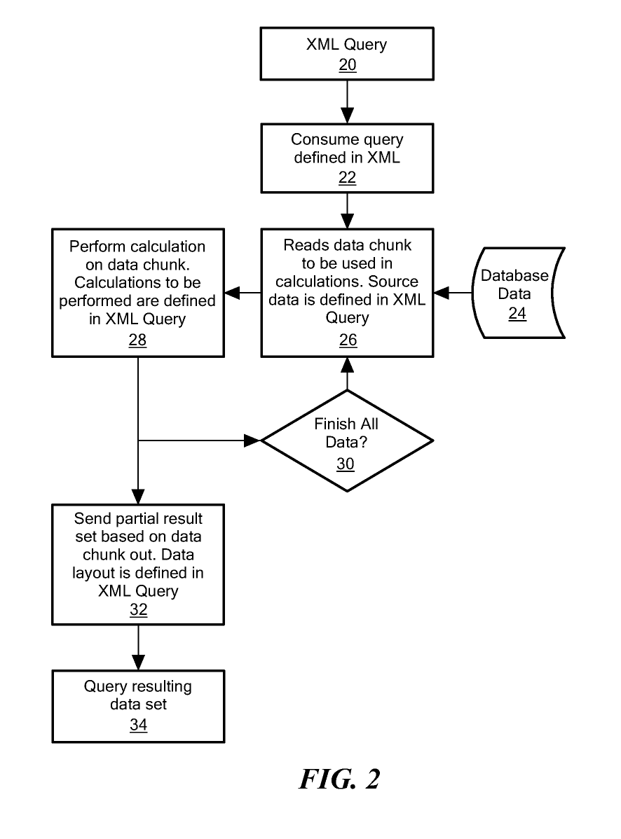

FIG. 2 is a flowchart illustrating the steps performed by calculation engine 12 upon data within database 14. After receiving XML query 20, calculation engine 12 consumes the query 20 and identifies the calculations defined in the XML, at step 22. Calculation engine 12 is in communication with data 24 from database 14 and reads a chunk of data from database data 24, at step 26. The source data is defined in XML query 20. Calculation engine 12 performs calculations on the data chunk, at step 28. These calculations are also defined in the XML query 20.

Calculation engine 12 continues to read all the data that it will perform calculations on until it has determined that there is no further data, at step 30. Calculation engine 12 need not perform calculations on the entire data set before generating results but instead may send out partial results, at step 32. The format and layout of the resulting data set is identified and embedded within the XML query 20. The resulting data set can then be queried, at step 34.

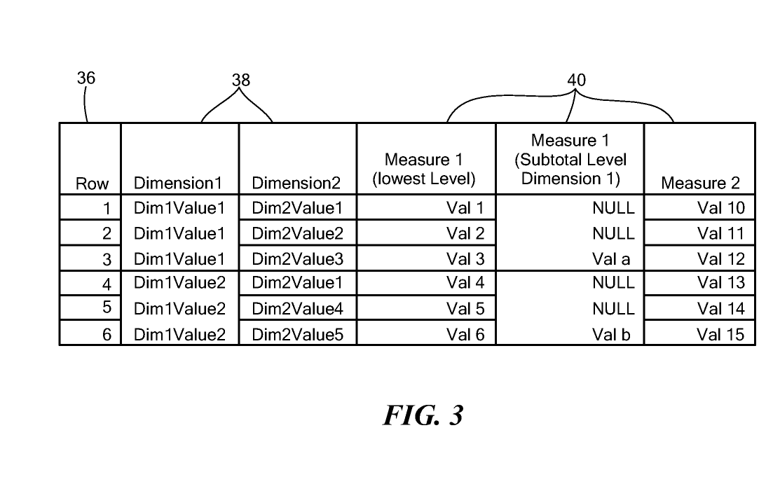

In one embodiment, as shown in FIG. 3, the resulting data set will return one row 36 for each individual resulting combination of all dimensions (i.e., Dimension1 and Dimension2, etc.) 38 specified in query 20. Dimensions 38 are mapped by the name specified in the section PrimaryDataSourceQuery in XML query 20 to the columns appearing in the resulting data set. In one embodiment, the resulting calculations or measures 40 may be provided as aggregated by each resulting row 36, per the description in the prior sentence. Measures 40 may accept in the XML query 20 scalar parameters and columns of data from the Primary Data Source section (defined as PrimaryDataSourceQuery) of the XML query 20.

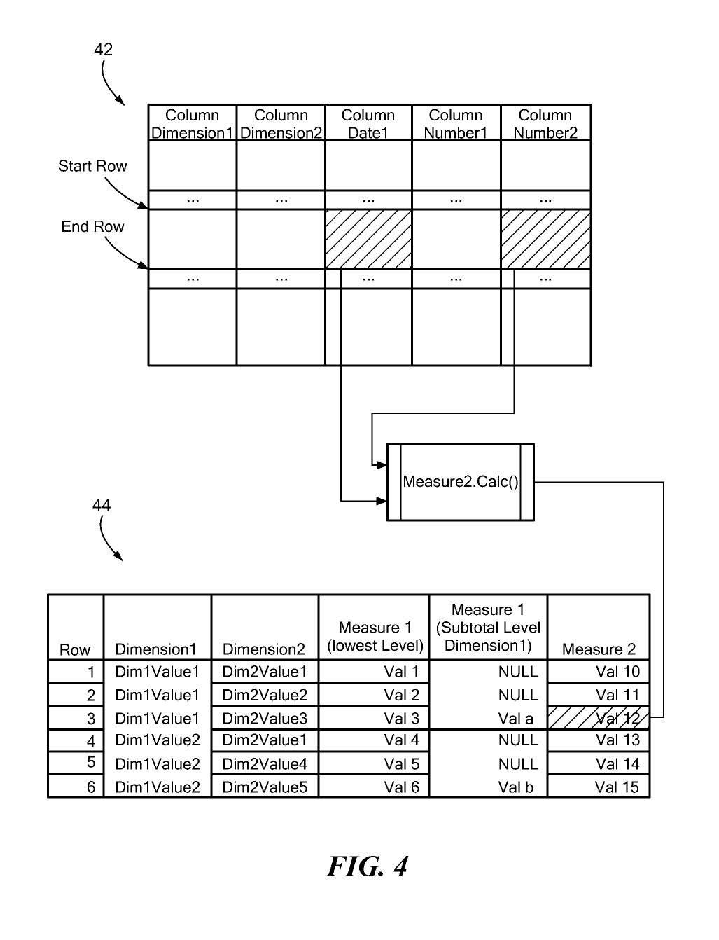

In one embodiment of the present invention, the same data set read from the primary data source is cached and used for all the calculations performed by calculation engine 12. FIG. 4 represents an exemplary embodiment of the present invention illustrating the relationship between entries in a data cache 42 and the output data set 44 produced by calculation engine 12. Data cache 42 is created by data fed from the primary data source defined in XML query 20. In one embodiment, the resulting data set organizes the data in hierarchical fashion, from the first dimension specified to the last. In the exemplary embodiment described above and shown in FIG. 4, the first value of Dimension 1 is repeated for all valid combinations of Dimension 2. This hierarchy can be applied for all dimensions specified in XML query 20, in the same sequential order that they are specified. The values of the dimensions are sourced from the query defined in the PrimaryDataSourceQuery section of XML query 20. The dimension names map to column names in the query 20 as specified in the PrimaryDataSourceQuery section of query 20. The hierarchy described above is exemplary and other hierarchies and mapping techniques may be employed.

Advantageously, in one embodiment of the present invention, a measure may require that specific subtotal values be calculated for each level of aggregation for each dimension. In the example shown in FIG. 4, “val a” represents the subtotal result for the “Dim1Value1” grouping. The value “val a” is presented at the last row of that grouping as the calculation of this value may require all data elements related to Dim1Value1 to be processed before a calculated value can be returned.

The method, system and computer program product of the present invention calculates and generates a resulting data set that can include subtotal calculations. This results in higher levels of performance. The inventive system incorporates a number of different strategies that achieve this higher performance. In one embodiment, and as discussed above, the same data set read from the primary data source is cached and used for all the calculations performed by calculation engine 12, thus avoiding the need to replicate data. This may be achieved by the usage of one or more independent pointers to areas of the data blocks within the data cache table 42 where those data blocks are used in all calculations. Thus, only the areas identified by the pointers are passed onto and used by calculation engine 12 in its calculations. These areas are identified in FIG. 4 by the cross-hatched regions. Thus, there is no physical movement of the data. Calculation engine 12 makes use of the pointers to read the data directly.

FIG. 4 illustrates the embodiment described above. In this example, every row for the results of Measure2 is a function of the vectors of data between “Start Row” and “End Row” for the columns labeled “Date1” and “Number2”. The columns used in data cache 42 and used for any given calculation are defined in XML query 20. The Start Row and End Row for a given calculation may be defined for any change in value for a combination of the dimensions defined in XML query 20. In the example above, the Start Row and End Row are defined for every change in the combination for Dimension1 and Dimension2.

In another embodiment, as calculation engine 12 performs, results are immediately returned in the resulting data set 44. For example, if 100 million rows are fed into calculation engine 12 and only the first 100 rows are required to return the first row of the resulting dataset 44, calculation engine 12 executes the calculations for the first resulting row once the process of feeding data into calculation engine 12 from the primary data source reaches the 100^{th} row. Once the calculations for the first resulting row are performed, calculation engine 12 will return that first resulting row to a consuming system while the other rows from the primary data source continue to be fed into calculation engine 12. Advantageously, this strategy improves throughput by avoiding the necessity that all calculations are required to be done prior to returning even the first resulting set data row.

In another embodiment, calculations are done independently for each measure. In other words, a parallel processing strategy is applied in order to calculate simultaneously multiple measures or calculations. This takes advantage of hardware systems commonly available in the market that employ multiple processors. For example, if XML query 20 contains 16 measures and the system running calculation engine 12 is capable of 16 processors, then all 16 measures can be calculated at the same time or virtually the same time, performing approximately 16 times faster than by sequentially calculating the measures.

The resulting data set generated by calculation engine 12 follows the same format of data output generated by database 14 where the primary data source resides. This means that any system that consumes data generated by database 14 (using, for example, an SQL query or an MDX query) will also be able to consume the resulting data set from the system. Queries done within database 14 will also be able to directly consume the system resulting data set.

The present invention can be realized in hardware, software, or a combination of hardware and software. Any kind of computing system, or other apparatus adapted for carrying out the methods described herein, is suited to perform the functions described herein.

A typical combination of hardware and software could be a computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for performing calculations on data in a primary data source, the method comprising:
analyzing an Extensible Markup Language (XML) query statement;
reading relevant data from the primary data source;
applying calculations specified in the XML query statement to the relevant data; and
generating a resulting data set per the XML query statement.

2. The method of claim 1, further comprising generating audit log data describing the step of applying calculations specified in the XML query statement to the relevant data.

3. The method of claim 1, wherein the XML query statement includes a description of one or more components used in the step of generating a resulting data set per the XML query statement.

4. The method of claim 3, wherein the one or more components include one or more of layout of the resulting data set, identity of the primary data source, measures defining behavior for the calculations, and data mapping between the primary data source and the relevant data.

5. The method of claim 1, wherein the resulting data set includes one or more dimensions and one or more measures, the one or more measures containing calculated values.

6. The method of claim 5, further comprising calculating a subtotal value for each level of aggregation for each of the one or more dimensions.

7. The method of claim 1, further comprising caching the relevant data, wherein the calculations specified in the XML query statement are applied to the cached data.

8. The method of claim 7, further comprising:
identifying portions of the cached data; and
using the identified portions of the cached data in the step of applying calculations specified in the XML query statement to the relevant data.

9. The method of claim 1, wherein the resulting data set includes a plurality of calculated values, further comprising:
applying calculations to a portion of the relevant data during the step of reading relevant data from the primary data source; and
generating a portion of the plurality of calculated values, the portion of the plurality of calculated values corresponding to the portion of the relevant data upon which the calculations are applied.

10. A system for performing calculations on data in a primary data source, the system comprising:
a database containing relevant data; and
a calculation engine adapted to:
analyze an Extensible Markup Language (XML) query statement;
read the relevant data from the database;
apply calculations specified in the XML query statement to the relevant data; and
generate a resulting data set per the XML query statement.

11. The system of claim 10, wherein the calculation engine is embedded within the database.

12. The system of claim 10, wherein the XML query statement includes a description of components used by the calculation engine to generate a resulting data set.

13. The system of claim 12, wherein the components include one or more of layout of the resulting data set, identity of the primary data source, measures defining behavior for the calculations, and data mapping between the primary data source and the relevant data

14. A computer program product tangibly embodied in a computer storage medium, for executing instructions on a processor, the computer program product being operable to cause a machine to:
analyze an Extensible Markup Language (XML) query statement;
read relevant data from the primary data source;
apply calculations specified in the XML query statement to the relevant data; and
generate a resulting data set per the XML query statement.

15. The computer program product of claim 14, wherein the computer program product generates audit log data describing the step applying calculations specified in the XML query statement to the relevant data.

16. The computer program product of claim 14, wherein the XML query statement includes a description of one or more components used in the generation of the resulting data set.

17. The computer program product of claim 16, wherein the one or more components include one or more of layout of the resulting data set, identity of the primary data source, measures defining behavior for the calculations, and data mapping between the primary data source and the relevant data.

18. The computer program product of claim 14, wherein the resulting data set includes one or more dimensions and one or more measures, the one or more measures containing calculated values.

19. The computer program product of claim 18, wherein the computer program product calculates a subtotal value for each level of aggregation for each of the one or more dimensions.

20. The computer program product of claim 19, wherein the computer program product identifies portions of the relevant data and uses the identified portions of the relevant data in the step of applying calculations specified in the XML query statement to the relevant data.
